(19) United States
(12) Patent Application Publication
(10) Pub. No.: US 2011/0233873 A1
(43) Pub. Date: Sep. 29, 2011

(54) Seal Arrangement

(75) Inventors: Horst Callies, Nagold (DE); Kurt Hornberger, Stuttgart (DE); Rene Schepp, Waiblingen (DE); Heiko Jahn, Tamm (DE); Marc Zimmermann, Southofen (DE); Norbert Alaze, Markgroeningen (DE); Oliver Amits, Paderborn (DE); Markus Andre, Ludwigsburg (DE)

(73) Assignee: Robert Bosch GmbH, Stuttgart (DE)

(21) Appl. No.: 13/057,691

(22) PCT Filed: Jun. 5, 2009
(86) PCT No.: PCT/EP09/56946

§ 371 Date: Jun. 15, 2011

(30) Foreign Application Priority Data
Aug. 5, 2008 (DE) 102008040994.4

(51) Int. Cl. F16J 15/32

(52) U.S. Cl. 277/549

(57) ABSTRACT

A seal arrangement includes a cylinder element, a piston which is accommodated in the cylinder element and can be driven to perform an axial reciprocating movement, and a sealing element for sealing a working space delimited by the piston and by the cylinder element, wherein the sealing element has a sealing side, a supporting side opposite the sealing side, a high-pressure side facing the working space to be sealed, and a low-pressure side facing away from the working space, and wherein the sealing side comprises at least one sealing lip formed by two converging sealing flanks of differing flank angles, wherein the sealing element is a component which is in the form of a single part, is composed of a standardized elastomer material, and has at least one marking for determining installation of the sealing element in the correct position.

### PRIOR ART

The invention relates to a seal arrangement comprising a cylinder element, a piston which is accommodated in the cylinder element and can be driven to perform an axial reciprocating movement, and a sealing element for separating off a working space delimited by the piston and by the cylinder element.

Single-part sealing elements manufactured from a standardized material are known from the prior art. Sealing elements are referred to by experts in the art as elastomer sealing elements. They are commercially available in different cross-sectional forms. For example, O-rings, quad rings or groove rings are known. Quad rings and groove rings have pressurizable sealing lips along the circumference thereof. The sealing lips advantageously provide an improved sealing action as the pressure load increases. Nevertheless, sealing elements of this type cannot prevent a certain amount of leakage of pressure medium, in particular if, due to the operating conditions, negative pressure is temporarily applied to the sealing element, as is customarily the case in seal arrangements for sealing pistons in cylinder units. A further technical challenge for the sealing element in piston/cylinder units consists in effectively sealing both a static state (inoperative, non-moving piston element) and a dynamic state (axially actuated piston element).

Especially for these cases, the prior art discloses sealing units which are of relatively complex configuration and are of multi-part design, for example rings which are made from plastic or Teflon prestressed by spring rings, or “sleeve sets”. Sealing units of this type customarily have an asymmetrically shaped sealing side and an accordingly asymmetrical contact pressure profile. Asymmetrical sealing profiles afford a considerable advantage in that they bring about a nonuniform hydrodynamic drag flow during the retracting and extending piston movement, owing to which medium can be effectively returned back into the working space to be sealed. If the piston moves into said working space (working stroke), a comparatively strong drag effect is achieved. By contrast, if the piston moves out of the working space to be sealed (suction stroke), then sealing elements having an asymmetrical profile are distinguished by a particularly low drag flow outward. On balance, effective return of medium into the working space and consequently a high sealing action are therefore obtained. The physical basic principle on which the explained return action is based has been scientifically investigated and is included in the prior art (see, for example, DE 103 60 601 A1). However, the described manner of operation presupposes installation of the sealing element in the correct position.

### ADVANTAGES OF THE INVENTION

Sealing elements on which the invention is based are of single-part design and combine the advantageous production properties of elastomer sealing elements with the favorable return properties of asymmetrical sealing geometries. They bring about an asymmetrical contact pressure profile which is obtained solely by means of the mechanical prestressing of the sealing elements in the fitting space in conjunction with the elastic material properties and the geometry of the sealing cross section thereof. Separate elements for the mechanical prestressing of the sealing elements are therefore not required.

In order to determine installation in the correct position, the sealing element is provided with at least one marking. Said marking can be integrally formed cost-effectively on the sealing element, advantageously interacts with a component adjacent to the sealing element and, if the sealing element is installed correctly, does not take up any additional construction space at all, but does so if said sealing element is incorrectly installed. As a result, incorrectly installed subassemblies can easily be determined, for example using a dimensional check which can be carried out in a technically simple manner, or a visual check.

Both types of check can be carried out at least in a partially automated manner and are therefore readily suitable for large-scale manufacturing.

Further advantages or advantageous developments of the invention emerge from the dependent claims and from the description below.

### DRAWING

An exemplary embodiment of the invention is illustrated in the drawing and is explained in detail in the description below. The single FIGURE shows a sealing element according to the invention in cross section.

### DESCRIPTION OF THE EXEMPLARY EMBODIMENT

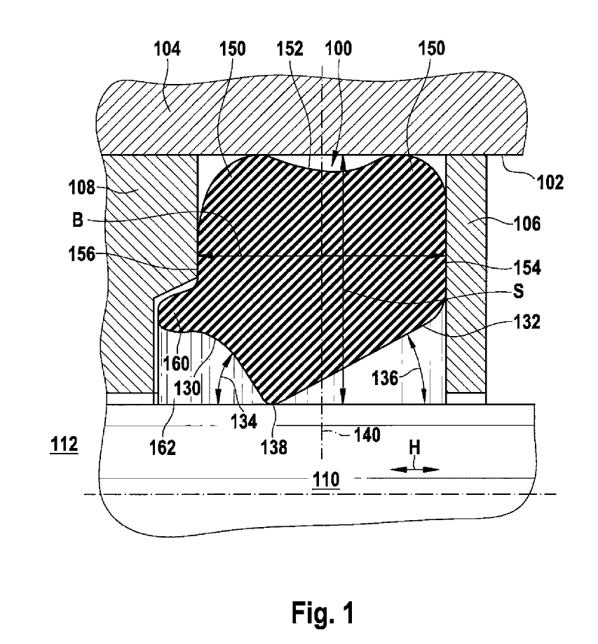

The sealing element 100 which is illustrated in the FIGURE is arranged fixed in position between a supporting ring 106 and a boundary element 108 in a bore 102 in a cylinder element 104. The sealing element is of annular design and, by way of example, with the inner circumference thereof, provides a seal in relation to the circumferential surface of a piston 110 and, at the outer circumference, provides a seal in relation to a bore wall of the cylinder element 104. The piston 110 can be driven to perform a reciprocating stroke movement H relative to the sealing element 100 and, for this purpose, is guided displaceably in the boundary element 108. The stroke movement H runs in the axial direction of the bore 102. A working space 112 to be sealed off by the sealing element 100 is delimited by the piston 110 and by the cylinder element 104 and is illustrated schematically in FIG. 1.

The sealing element 100 according to the invention is in the form of a single part and has a cross section with a substantially square basic shape. Said sealing element is composed of a standardized elastomer material, preferably of EPDM. The cross-sectional form is composed of four sealing element sides aligned at least approximately at right angles to one another, wherein said sealing element sides each differ in configuration.

The first sealing element side, which points downward in the FIGURE, bears against the circumferential surface of the piston 110 and forms the internal contour of the sealing element 100. The side is referred to below as the sealing side. The configuration of said sealing side is determined by two converging sealing flanks 130, 132 of differing flank angles 134, 136. A sealing lip 138 is formed at the transition from the one to the other sealing flank 130, 132. Said sealing lip is formed by a transition radius which is between 0.1 and 0.4 mm in size. Owing to the two of differing flank angles 134, 136, the sealing lip 138 in FIG. 1 is offset to the left with respect to a center axis 140, which runs perpendicularly to the stroke movement H, of the sealing element 100 and imparts an asymmetrical cross-sectional form to the latter.

The first sealing flank 130 is located on a side of the sealing element 100 that faces the working space 112. The flank angle 134 of said sealing flank is between 50° and 70°. In contrast, the second sealing surface 132 has a smaller flank angle 132 of only 10° to 45° and is arranged facing away from the working space 112 which is to be sealed on a “low-pressure side” of the sealing element 100. Both sealing flanks 130, 132 are, by way of example, of rectilinear design.

That side of the sealing element 100 which is opposite the sealing side is referred to as the supporting side. In the exemplary embodiment, said side is configured mirror-symmetrically to the center axis 140 and is bounded on its edges on the low-pressure side and high-pressure side by a respectively protruding bead 150. The two beads 150 are supported on the wall of the bore 102. A recess 152 extending symmetrically to both sides of the center axis 140 lies between the two beads 150 of the sealing element 100. Said recess 152 is curved concavely inward.

In the exemplary embodiment, the low-pressure side of the sealing element 100, which side faces away from the working space 112 which is delimited by the piston 110 and the cylinder element 108, is designed in the form of a rectilinear flank 154.

A side of the sealing element 100, which side faces the working space 112 and is referred to as the high-pressure side, lies opposite said low-pressure side. The high-pressure side is designed in sections as a rectilinear flank 156 and is provided with an integrally formed marking 160. The latter makes it possible to ensure that the sealing element 100 is installed in the correct position or to easily determine incorrectly installed sealing elements 100. The marking 160 is realized by way of example using a peripheral bead protruding substantially parallel to the stroke movement H of the piston 110. Said bead extends over part of the high-pressure side and merges seamlessly into the first sealing flank 130 of the sealing side.

On its side facing the sealing element 100, the boundary element 108 has a mating marking 162 in the form of a clearance which is shaped in an inverted manner with respect to the peripheral bead and completely accommodates the marking 160. In the illustrated state, the marking 160 therefore does not cause any increase in the fitting space existing between the guide element 108 and the supporting ring 106.

Of course, it would alternatively also be possible to design the marking 160 on the sealing element 100 as a clearance in which a projection integrally formed on the boundary element 108 engages, in order to determine sealing elements 100 not fitted in the correct position with reference to the increased construction space required by an installation unit consisting of the sealing element 100 and guide element 108.

The external dimensions of the sealing element 100 are coordinated with the internal dimensions of the cylinder element 104 or with the external dimensions of the piston 110 in such a manner that, in the unpressurized state of the seal arrangement and with the piston 110 inoperative and not actuated, the sealing element 100 is compressed at between 8% and 25%. The ratio of the width B to the cord thickness S of the sealing element 100 lies within the range of between 0.5 and 2.0 if the sealing element 100 is in the unpressurized state. FIG. 1 illustrates the cross section of the sealing element 100 in the noncompressed state, since the cross-sectional profile described can only be seen in this state.

Owing to the compression of the sealing element 100 in combination with the differing flank angles 134, 136 of the sealing flanks 134, 136 forming the sealing lip 138, a predefined contact pressure profile arises, with which the sealing element 100 is pressed against the circumferential surface of the piston 110. Maximum contact pressure is exerted on the piston 110 by the sealing element 110 in the region of the sealing lip 138 thereof. The contact pressure decreases continuously in the axial direction on this side and the other side of the sealing lip 138, the gradient of the contact pressure decrease being directly associated with the size of the flank angle 134, 136 of the associated sealing flanks 130, 132 and continuously increasing with the flank angle 134, 136 within the previously stated angular range. This means that a sealing flank having a large flank angle causes a steeper decrease in the contact pressure (large gradient) than a sealing flank having a smaller flank angle (smaller gradient). As already mentioned, the sealing flank 130 on the high-pressure side has a larger flank angle 134 and therefore a greater gradient than the sealing flank 132 on the low-pressure side.

Upon movement of the piston 110 in the direction of the high-pressure side, i.e. when the piston 110 is retracted into the working space 112, the different gradients cause a comparatively high drag flow, and therefore pressure medium which has previously emerged is conveyed back into said working space 112 which is delimited by the piston 110 and by the cylinder element 104.

The outer sides of the sealing element 100 merge continuously into each other at their respective edges, i.e. without shoulders, steps, pointed edges or the like. A continuous transition firstly enables easy removability of the sealing element 100 from its mold during production and, furthermore, has an advantageous effect with regard to the sealing properties of the sealing element 100 during use.

Of course, amendments or additions to the exemplary embodiment described are conceivable without departing from the basic concept of the invention. Sealing elements according to the invention are suitable in particular for use in piston pumps or pressure accumulators in hydraulic units of slip-controllable hydraulic vehicle braking systems.

1. A seal arrangement comprising:
a cylinder element,
a piston located in the cylinder element and configured to be driven axially in a reciprocal path of movement, and
a sealing element configured to seal a working space delimited by the piston and by the cylinder element,
wherein the sealing element has a sealing side, a supporting side opposite the sealing side, a high-pressure side facing the working space, and a low-pressure side facing away from the working space,
wherein the sealing side comprises at least one sealing lip having two converging sealing flanks of differing flank angles,
wherein the sealing element is formed from a single elastomeric part, and
wherein the sealing element has at least one marking configured to determine proper installation of the sealing element.

2. The seal arrangement as claimed in claim 1, wherein the at least one marking is arranged on the high-pressure side of the sealing element.

3. The seal arrangement as claimed in claim 2, wherein the marking includes a peripheral bead protruding from the sealing element in the direction of a stroke movement of the piston.

4. The seal arrangement as claimed in claim 1, wherein the marking interacts with a mating marking on a component which is adjacent to the sealing element, the mating marking and the marking engaging one inside the other substantially without causing any increase in the construction space required by the sealing element and by the adjacent component.

5. The seal arrangement as claimed in claim 1, wherein the sealing element is configured to be used in one of a piston pump and a pressure accumulator of a hydraulic unit of a slip-controllable hydraulic vehicle braking system.

6. The seal arrangement as claimed in claim 1, wherein the single elastomeric part is made of EPDM.

7. A seal arrangement comprising a cylinder element, a piston which is accommodated in the cylinder element and can be driven to perform an axial reciprocating movement, and a sealing element for sealing a working space delimited by the piston and by the cylinder element, wherein the sealing element has a sealing side, a supporting side opposite the sealing side, a high-pressure side facing the working space to be sealed, and a low-pressure side facing away from the working space, and wherein the sealing side comprises at least one sealing lip formed by two converging sealing flanks of differing flank angles, wherein the sealing element is a component which is in the form of a single part, is composed of a standardized elastomer material, and has at least one marking for determining installation of the sealing element in the correct position.

8. The seal arrangement as claimed in claim 7, wherein the at least one marking is arranged on the high-pressure side of the sealing element.

9. The seal arrangement as claimed in claim 8, wherein the marking is embodied in the form of a peripheral bead protruding from the sealing element in the direction of a stroke movement of the piston.

10. The seal arrangement as claimed in claim 7, wherein the marking interacts with a mating marking on a component which is adjacent to the sealing element, the mating marking and the marking engaging one inside the other substantially without causing any increase in the construction space required by the sealing element and by the adjacent component.

11. The seal arrangement as claimed in claim 7, wherein the sealing element is used in a piston pump and/or a pressure accumulator of a hydraulic unit of a slip-controllable hydraulic vehicle braking system.

12. The seal arrangement as claimed in claim 7, wherein the single part is EPDM.
